(19) United States
(12) Patent Application Publication
(10) Pub. No.: US 2014/0110321 A1
(43) Pub. Date: Apr. 24, 2014

(54) Liquid Filter and Engine Subassembly Acting as a Support on which to Mount a Filter Canister

(71) Applicant: FILTRAUTO, Guyancourt (FR)

(72) Inventors: Raphaël Bertin, Les Clayes sous Bois (FR); Thierry Alnot, Montigny le Bretonneux (FR)

(21) Appl. No.: 14/124,795

(22) PCT Filed: Jun. 5, 2012
(86) PCT No.: PCT/FR2012/051246

§ 371 Date: Dec. 9, 2013

(30) Foreign Application Priority Data
Jun. 9, 2011 (FR) 1155031

(51) Int. Cl. B01D 35/00

(52) U.S. Cl. CPC B01D 35/005
USPC 210/167.08

(57) ABSTRACT

The mounting support (S) for a filter canister (2) comprises a base (30) connected to the lubrication circuit of an internal combustion engine and an attachment interface for the canister, the base (30), of plastic material, having a liquid inlet (31) and a liquid outlet (32), the attachment interface (40) being a single piece, preferably metal, which has: an axial sleeve (41) connecting with the canister, a first annular sealing zone (51) being formed between the base (30) and the axial sleeve; an annular external portion (42) integral with the sleeve and connected to the base by forming a second annular sealing zone (52); at least one opening (43) enabling liquid to circulate between the first and second sealing zones and communicating with the inlet or outlet. A filter comprising the support (S) and the canister (2) is also described.

The present invention concerns liquid filters and engine subassemblies acting as a support on which to mount a filter canister.

More specifically, the invention concerns a mounting support for a filter canister for liquid (for example, engine lubrication oil) of a type comprising a housing delimiting an interior volume in which a filter element is placed, the mounting support comprising:

a base intended to be connected to a lubrication circuit for an internal combustion engine, the base having an inlet for raw lubrication fluid, an outlet for purified lubrication fluid, and a conduit that communicates with one of said inlet and said outlet,

an axial sleeve connected in leakproof manner to the conduit of the base and which forms part of a metal attachment interface for contact with the filter canister.

This type of mounting support is known, for example, in document U.S. Pat. No. 2,877,902. The connection interface described in that document has a central insert delimiting the axial sleeve communicating with a raw liquid inlet passageway and a peripheral part provided with an outlet that communicates with a purified liquid outlet passageway of the crimped canister. Mounting the connection interface on the metal base occurs by screwing the central insert into internal threads formed in a central orifice of the base. This type of connection interface can be used to rapidly and easily attach the filter canister, and is suitable for use with conventional filter canisters (of the spin-on type) whose housing is formed of a fine layer of metal.

The system described in document U.S. Pat. No. 2,877,902 requires the assembly of several parts in the engine block and, therefore, requires that the manufacturer assemble parts in the casting of this engine block. Consequently, this system is complex and expensive. U.S. Pat. No. 3,300,049 describes an adapter kit for a filter canister, which kit must be mounted on the base. Another disadvantage of this type of kit is the complexity of assembling the connection interface, involving a combination of metal parts and seals for contact with the base.

Moreover, the base and the associated attachment interface are often of considerable bulk and the metal mass formed by the assembly is quite heavy. This does not facilitate assembly operations and has a negative impact on the weight of the vehicle.

Significantly, the object of the present invention is to overcome one or more of the drawbacks found with quick assembly filter canister systems (known as “spin-on” by the skilled practitioner, and which can be screwed on or attached by a bayonet type connection).

To that end; it is provided according to the invention a mounting support of the aforementioned type (which can be used for various vehicle engines) wherein the base is of plastic material and the metal attachment interface comprises:

the metal, axial sleeve, which defines an axial passageway that communicates by a first extremity of the sleeve with one of the inlet and outlet of the base, a first annular sealing zone being formed between the base and the axial sleeve of the attachment interface, the axial sleeve having attachment means chosen from among threads, pins, or notches at a second extremity, allowing the filter canister to be attached,

an annular external metal portion joined to the axial sleeve and connected in leakproof manner to the base through the formation of a second annular sealing zone between the base and the attachment interface, at a distance from the first annual sealing zone, and

at least one opening allowing liquid to circulate between the first and second sealing zones, this opening communicating with the other of said inlet and said outlet of the base. Preferably, the attachment interface is a one-piece unit, so that the annular external portion is integral with the axial sleeve.

Because of these arrangements, the number of parts to be assembled is reduced. A mounting support that is lighter in weight can also be used, while taking advantage of the rigidity of the attachment interface (and a surface condition that remains good after the canister has been mounted and unmounted several times), which enables a satisfactory axial seal with the filter canister to be obtained. An advantageous compromise is obtained between the use of plastic for the base, which reduces the weight, and the simplicity and robustness of the standard spin-on type canister connection (where the external housing is typically metal).

According to a particular feature, the axial seal has a central axis and the support comprises antirotation means formed on both the base and the attachment interface in order to prevent rotation around the central axis of the attachment interface with respect to the base. Given this arrangement, it can be seen that the attachment interface remains inseparable from the base and, therefore, forms a robust part of the support.

In various embodiments of the mounting support according to the invention, we can have recourse to one and/or the other of the following arrangements:

antirotation means present a notch formed on the sleeve and a complementary outward projection formed on the internal face of the conduit of the base (the system with the notch can also be used to guide insertion of the lower extremity of the sleeve into the associated conduit on the base);

the attachment interface has a plurality of spacers between the sleeve and the annular external portion, the openings being arranged respectively between two adjacent spacers in an annular space formed between the sleeve and the annular external portion (with this arrangement, a part with a significant periphery can be obtained while minimizing the amount of material used in the space between the sleeve and the annular external portion);

antirotation means comprise outward projections formed integrally with the base, each of the spacers extending through a space formed between adjacent outward projections (thus, an antirotation lock can be realized at a distance from the annual sealing zones, for example, on the side of the internal extremities of the spacers);

the first extremity of the axial sleeve projects axially toward the exterior from a transverse plane defined by an upper face of the annual external portion to form a male connection element, preferably provided with threads;

the first extremity of the sleeve is welded to the conduit on the base, the weld zone forming said first sealing zone;

the annular external portion of the attachment interface has an external face on which is formed a peripheral groove opening radially outward, an annular seal being arranged in the groove and resting against a tubular wall of the base to form said second annular sealing zone;

the base has an internal collar that surrounds the axial sleeve, the annular external portion extending around the internal collar.

Another object of the invention is a relatively low weight liquid filter that uses standard canisters.

To that end, a liquid filter is proposed, comprising a filter canister and a mounting support for the filter canister, wherein the support comprises a base of lightweight material such as plastic, and wherein the filter canister comprises an external housing (preferably metal) delimiting an interior volume containing a filter element separating said interior volume into an upstream space and a downstream space, and wherein the housing comprises a bottom delimiting at least one liquid inlet passageway communicating with the upstream space and a liquid outlet passageway communicating with the downstream space, the housing being suitable for mounting on the support, which has a liquid inlet channel provided to communicate with the inlet passageway and a liquid outlet channel provided to communicate with the outlet passageway, the mounting support being such as defined according to the invention. Thus, the filter may possess satisfactory rigidity for contact surfaces that may be repeatedly called into use when the support interface and the canister are connected and disconnected.

According to a feature, the support has a heat exchanger, the base presenting, in the extension of the axial conduit, a support portion for the heat exchanger.

According to another feature, the annular external portion of the attachment interface has an external diameter that is appreciably equal to the external diameter of the canister housing. Thus, the attachment interface does not add any additional space in the radial direction with respect to the canister housing.

Other characteristics and advantages of the invention will appear from the following description of several of its purely non-limiting embodiments, which are provided with respect to the attached drawings, in which:

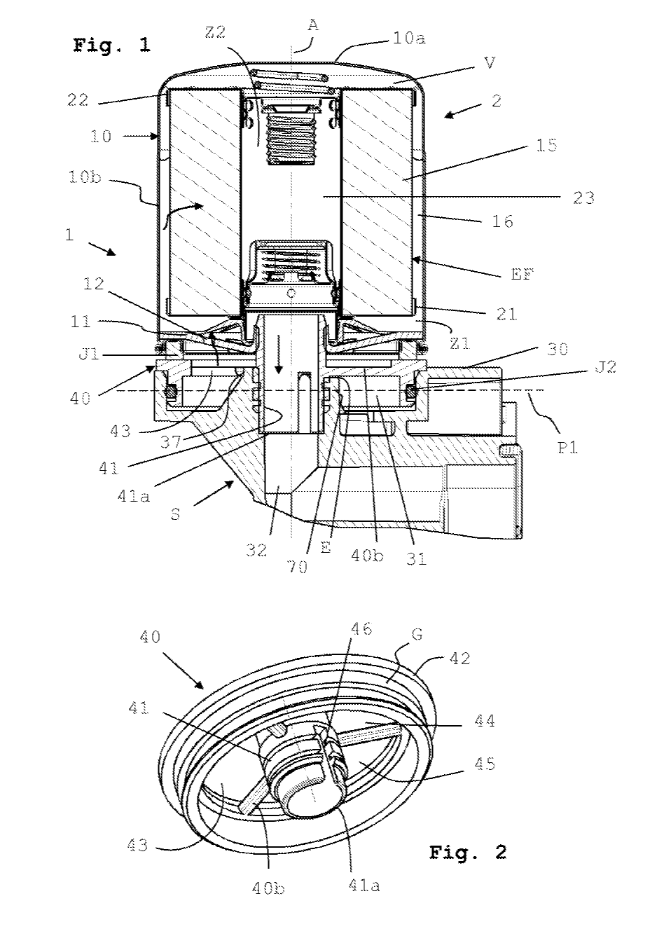

FIG. 1 is a longitudinal cutaway showing a filter according to the invention, with the filter canister mounted on the mounting support;

FIG. 2 is a perspective view illustrating the attachment interface of the mounting support of FIG. 1;

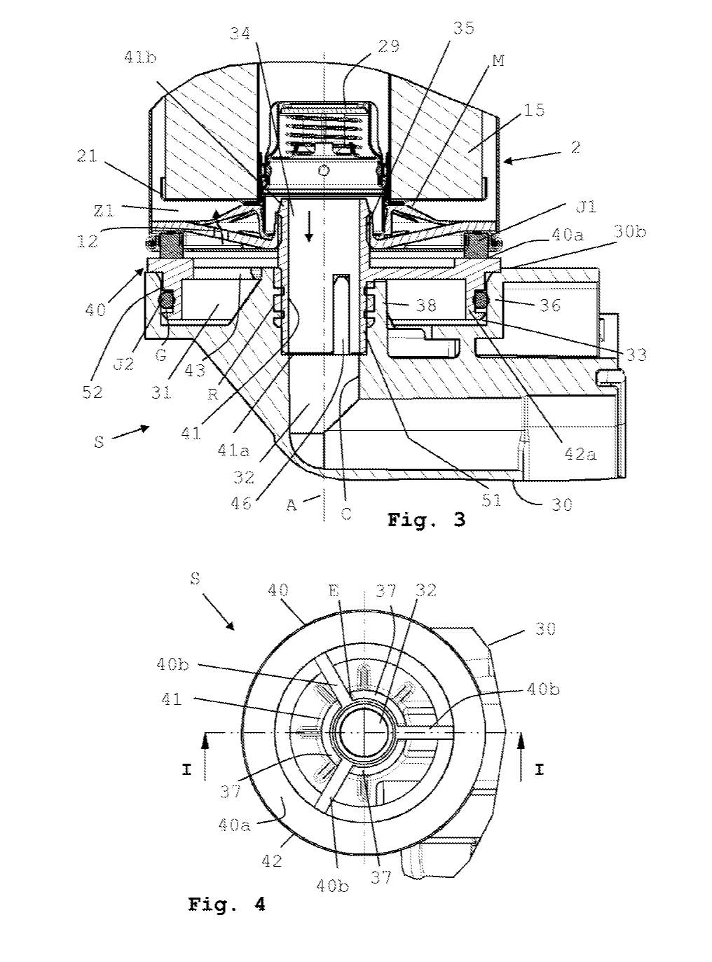

FIG. 3 is an enlargement of FIG. 1, which illustrates the attachment of the filter canister on the mounting support through the use of the attachment interface;

FIG. 4 is a top view of a mounting support according to the invention illustrating the attachment interface connected to the base of the support; and

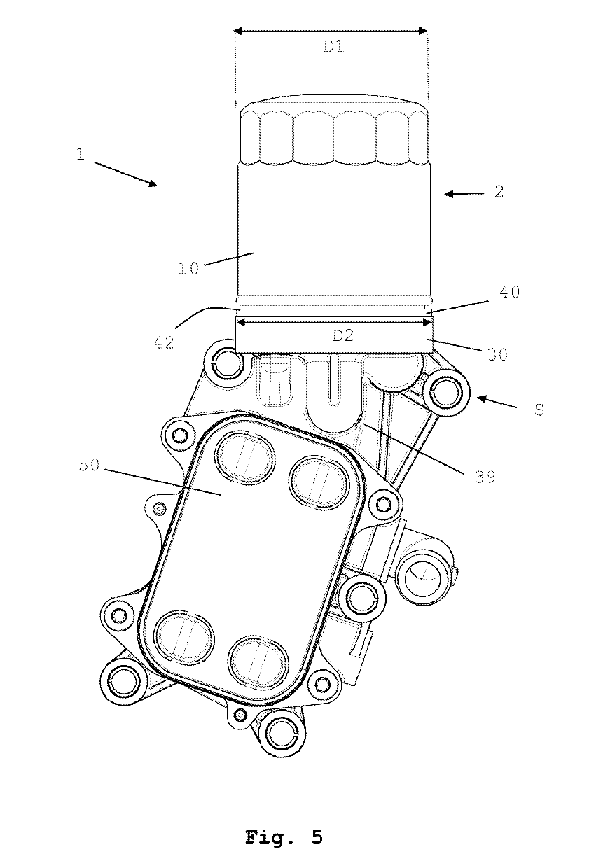

FIG. 5 illustrates an external view of a filter according to the invention.

In the different figures, the same reference numbers refer to identical or similar elements.

With reference to FIGS. 1 and 2, liquid filter 1 has reusable support S and filter canister 2. As can be seen in FIG. 1, filter canister 2 has an external housing, 10, delimiting an interior volume, V, containing a filter element, EF. Housing 10 may have a domed summit, 10a, and a lateral wall, 10b, extending around filter element EF from domed summit 10a to a lower extremity, 11, of housing 10. Lateral wall 10b is, preferably, appreciably cylindrical and not provided with an opening, the liquid inlet, 12, and the liquid outlet, 13, being arranged on lower extremity 11. Lower extremity 11 here consists of a wall forming the bottom of filter canister 2

In the non-limiting example of FIG. 1, filter element EF has a lower flange, 21, an upper flange, 22, and a filter medium, 15, through which the liquid to be filtered, for example, lubricating oil, can pass. Filter medium 15 delimits a hollow interior space, 23.

Filter element EF separates interior volume V into an upstream space, Z1, and a downstream space, Z2. Filter element EF is appreciably tubular. Upstream space Z1 corresponds to an oil inlet space in canister 2, before filtration, in the lower portion of filter 1 and along the periphery (annular space 16 formed around filter medium 15). Downstream space Z2 corresponds to interior space 23, in which the filtered oil circulates.

In a manner known per se, filter medium 15 is placed between lower flange 21 and upper flange 22 and can be used to filter impurities contained in the oil. Here, filter medium 15 has an annular shape through its extension around a central axis, A, which defines a longitudinal direction of canister 2.

Lower extremity 11 delimits a liquid inlet passage that preferably has a plurality of orifices, 12, arranged in the bottom of housing 10. Orifices 12 communicate with the periphery of interior volume V in such a way that the raw liquid can circulate within annular space 16. This communication occurs by means of check valve M situated in the lower portion of housing 10. This valve may possess the form of a flexible membrane. In this example, the membrane is thinner along its peripheral edge. Valve membrane M is open when liquid circulates under pressure from inlet channel 31 toward interior volume V of housing 10.

As is visible in FIGS. 1, 3, and 5, canister 2 is designed for mounting on support S arranged on an engine block and which has inlet channel 31 and outlet channel 32. Extremity 11, forming the bottom of housing 10, also has outlet passageway, 34, which is central, with threads, 35, for attaching canister 2 to an axial sleeve, 41, of outlet channel 32 of support S. The plurality of orifices of the inlet passageway are, therefore, situated around outlet passageway 34 of canister 2. A seal, J1, for example, of a kind with a square cross-section, is attached to the external surface of lower extremity 31 to realize a seal around the intervening space formed between orifices 12 on the bottom of canister 2 and the outlet of inlet channel 31. Seal J1 is here received in a groove adjacent to the crimping area of canister 2. Of course, other modes of attaching seal J1 to canister 2 can be used.

Here, support S has a base, 30, connected to the lubrication circuit for an internal combustion engine, and an attachment interface, 40, formed from a single piece to attach filter canister 2. Inlet 31 for raw lubrication liquid and outlet 32 for purified lubrication liquid are here formed in base 30 of support S. Seal J2, which can be toric or similar, can be used to create the seal around attachment interface 40 in a recessed annular zone (near the interior of base 30) with respect to seal surface 40a, which is in contact with seal J1. Here, base is made of molded plastic material, which helps to reduce the weight of the lubrication circuit.

As can be seen in FIGS. 2, 3, and 4, attachment interface 40 comprises:

a metal axial sleeve, 41, extending between a first lower extremity, 41a, inserted in corresponding axial conduit C of base 30 (which axial conduit defines outlet 32 in this non-limiting example) and a second upper extremity, 41b, forming a connector for canister 2;

a metal annular external portion, 42, integral with axial sleeve 41 and connected in leakproof manner to base 30; and

one or more openings, 43, 44, 45, arranged between axial sleeve 41 and annular external portion 42 to enable off-center liquid circulation from inlet 31 to the inlet passageway of canister 2.

The one-piece design is preferred because installation and leakproof anchoring of attachment interface 40 are particularly easy. In a variant embodiment, attachment interface 40 can also be obtained by interconnecting two metal parts with, for example, a junction at a distance from the sealing zones (possibly near spacers 40b).

As can be seen in particular in FIG. 3, sleeve 41 internally defines an axial passage in the extension of axial conduit C. In the mounted position of canister 2, as shown, for example, in FIGS. 1 to 3, the axial passageway emerges here, at its second extremity, 41b, in interior volume V. This emergence may possibly be flush with or be situated in interior space 23, delimited by filter medium 15. In this case, sleeve 41 extends about an axis of revolution that is indistinguishable from central axis A in the mounted position of canister 2. Sleeve 41 is connected in leakproof manner to axial conduit C of base 30, a first annular sealing zone 51 between base 30 and attachment interface 40 being, for example, formed around axial sleeve 41, preferably on the side of first extremity 41a. In a variant or additional embodiment, a sealing contact can also be realized at the free edge of first extremity 41a of sleeve 41, conduit C being capable, in this case, of presenting a shoulder forming a sealing surface.

Annular external portion 42 is connected in leakproof manner to base 30 at a distance from first annular sealing zone 51. External portion 42 of attachment interface 40 therefore has a peripheral groove, G, which is formed on its external face. Seal J2 is placed in groove G and rests upon wall 36, here cylindrical, of base 30. Wall 36 delimits an annularly shaped recess formed in base 30, referred to below as annular entrance housing 33, wherein a lower extremity of annular external portion 42 can be accommodated. Groove G is arranged in this lower extremity. It can be seen that a second annular sealing zone 52, between base 30 and attachment interface 40, is formed by means of seal J2, squeezed between lower extremity 42a and wall 36.

Openings 43, 44, 45, which are formed between sealing zone 51 and second sealing zone 52, [enable inlet 31] are here relatively large and enable communication with the inlet passageway of canister 2. Attachment interface 40 here has three spacers 40b connecting sleeve 41 to annular external portion 42. Attachment interface 40 consists of a metal piece, for example, of aluminum or steel, so that contact with canister 2 can be of the metal-metal kind when the canister is mounted (for example, by screwing) on support S.

In the example of FIGS. 1 and 3, the female element equipped with threads 35 formed on canister 2, cooperates with second extremity 41b of sleeve 41, also provided with threads to form the male element of the leakproof connection. While attachment of canister 2 is realized by means of movable attachment means, attachment of attachment interface 40 to base 30 is a permanent connection and can be realized by thermal treatment of first extremity 41a of sleeve 41 inserted into axial conduit C. In a preferred embodiment, anchorage of metal attachment interface 40 in plastic base 30 occurs by induction welding (electromagnetic induction heats first extremity 41a of attachment interface 40).

Antirotation means are provided to maintain a predetermined angular position of attachment interface 40, welded or connected by any other method to base 30 so as to prevent connection interface 40 from being torn out. In a non-limiting example, sleeve 41 has one or more notches 46, which engage with outward projections formed on the internal face of axial conduit C. Notch 46, visible in FIGS. 1 to 3, emerges axially on the side of first extremity 41a and has an elongated shape. In this example, first extremity 41a has an axial opening emerging directly into axial conduit C. As is clearly visible in FIG. 1 and FIG. 3, base 30 can present an internal collar, 70 (integral with base 30), which extends annularly around sleeve 41. This internal collar 70 improves the anchoring of attachment interface 40 and helps to very significantly reduce the length of sleeve 41. We can also see that there exists a virtual plane, P1, perpendicular to central axis A, which traverses both internal collar 70 and seal J2, which extends the length of an external circumference of attachment interface 40. With these arrangements, we increase the contact surface between base 30 and sleeve 41. We obtain a very reduced height dimension of attachment interface 40 without requiring additional attachment parts (no nut, for example).

With reference to FIGS. 1 to 4, the rotation of attachment interface 40 is also prevented by spacers 40b, which are engaged by outward projections 37 integral with base 30. These projections 37 are here formed on the upper face of the central portion of connector 38 of base 30, which defines the upper extremity of axial conduit C. This central connecting portion 38 itself projects into the annular space formed between sleeve 41 and annular external portion 42. Thus, in this non-limiting example, the central portion of connector 38 comprises, on the one hand, internal collar 70 and, on the other hand, an annular lower portion in the axial extension of internal collar 70. Projections 37 are annularly distributed with respective spaces E between two adjacent projections. Each of spacers 40b is placed, during integration with support S of attachment interface 40, across one of spaces E.

As can be seen in FIG. 4, the portion of spacers 40b adjacent to sleeve 41 is squeezed between two projections 37, which inhibit rotation of attachment interface 40 around central axis A when mounting or unmounting canister 2.

Insertion of sleeve 41 in axial conduit C can be limited by stop means. In the embodiment shown, the stop means comprise an annular exterior shoulder formed on the external face of external annular portion 42. This shoulder rests on upper surface 30b of base 30 but does not penetrate annular inlet housing 33. Additionally, first extremity 41a of sleeve 41 can have projecting reliefs R, which engage with the internal face of axial conduit C. Advantageously, anchorage of attachment interface 40 in central portion 38 of base 30 can thus be improved by creating a knurled surface or “pine tree” type shape at the external surface of sleeve 41 (on the side of first extremity 41a, as can be seen in FIGS. 1 to 3).

Mounting of filter canister 2 on support S will now be described in connection with FIGS. 1 to 3.

Attachment interface 40, formed of a single piece, is integral with base 30 and here defines all the contact surfaces with spin-on canister 2. External annular portion 42 of attachment interface 40 has a sealing surface 40a on which seal J1 of canister 2 (or other equivalent sealing means) rests upon 2 whenever the operator screws or connects in similar manner canister 2 on attachment interface 40. Sealing surface 40a, which is appreciably plane, is defined by the upper face of external annular portion 42.

Filter canister 2, here of the crimp type, extends longitudinally along central axis A. The lower extremity 11 of housing 10 can be metal and threads 35 are preferably coaxial to central axis A in such a manner that the complementary threads of sleeve 41 extend around the same central axis A to enable conventional screw assembly.

The rigidity of sleeve 41 allows screw assembly of a metal housing 10 canister without alteration of threads 35, which ensures a good seal around exit passageway 34. Antirotation means (37, 40b; 46), here formed between the external face of sleeve 41 and the internal face of the annular external portion 42 and/or in the contact zone between sleeve 41 and axial conduit C, enable screw assembly without rotation of attachment interface 40, in spite of the tightening torque.

When canister 2 is mounted tightly on support S, in normal operating position, as shown in FIGS. 1 and 3, inlet channel 31 of base 30 of support S communicates with the inlet passageway of the canister via openings 43, 44, 45. Outlet channel 32 of base 30 of support S communicates with outlet passageway 34 of canister 2 through the axial passageway of sleeve 41.

Canister 2 can then be unmounted from its support S. In this case, antidrainage valve 29, connected to outlet passageway 34, is closed to prevent the interior volume of the filter from emptying out through outlet passageway 34. This antidrainage valve 29, arranged in downstream space Z2, opens, in a manner known per se, only when the pressure in the downstream space is greater than a predetermined value. The membrane of check valve M is closed to prevent the interior volume of the filter from emptying out through the inlet passageway.

It can be seen that the mounting operation is rapid and remains conventional for the operator. Unmounting is also conventional. The wear associated with mounting and unmounting operations of filter canister 2, for support S with its plastic base 30, is comparable to the wear found when using a fully metallic support.

With reference to FIG. 5, base 30, fabricated from plastic material, has, in the extension of said axial conduit C, a support portion 39 of heat exchanger 50. This exchanger 50 can be a conventional type used to exchange heat between water or a similar cooling liquid and the lubrication liquid being filtered. Therefore, it can be seen that support S can also serve as a water-oil exchanger.

Annular external portion 42 of attachment interface 40 has an external diameter D2 that is appreciably equal to the external diameter D1 of housing 10 of canister 2. Only the annular exterior shoulder of attachment interface 40 is visible from the exterior of filter 1 in the mounted position of canister 2. Therefore, it can be seen that the additional space requirement created by attachment interface 40 is very small.

It should be obvious to those skilled in the art that the present invention allows for many other specific forms of embodiment without diverging from the field of application of the invention as claimed. For example, attachment interface 40 can, alternatively, present a female screw assembly element or comparable attachment means, lower extremity 11 of canister 2, in this case, having a complementary male element or similar nipple.

1. A mounting support for a filter canister provided with an external housing, said support having:
a base intended to be connected to a lubrication circuit for an internal combustion engine, the base having an inlet for raw lubrication fluid, an outlet for purified lubrication fluid, and a conduit that communicates with one of said inlet and said outlet,
an axial sleeve connected in leakproof manner to said conduit, said axial sleeve forming part of a metallic attachment interface for contact with the filter canister,
wherein the base is of plastic material,
and wherein said attachment interface comprises:
said metal, axial sleeve, which defines an axial passageway that communicates by a first extremity of the axial sleeve with one of said inlet and said outlet of the base, a first annular sealing zone being formed between the base and the axial sleeve of the attachment interface, the axial sleeve having attachment means chosen from among threads, pins, or notches, provided on a second extremity, allowing the filter canister to be attached,
a metal annular external portion integral with the axial sleeve and connected in leakproof manner to the base while forming a second annular sealing zone between the base and the attachment interface, at a distance from the first annual sealing zone, and
at least one opening allowing liquid to circulate between the first and second sealing zones, said opening communicating with the other of said inlet and said outlet of the base.

2. The support according to claim 1, wherein the attachment interface is a one-piece metal part.

3. The support according to claim 2, wherein the axial sleeve is directly inserted by its first extremity into the conduit of the base, the first annular sealing zone being formed around the axial sleeve.

4. The support according to claim 3, wherein the axial sleeve has a central axis (A), the support comprising antirotation means formed on both the base and the attachment interface to prevent rotation of the attachment interface with respect to the base around the central axis.

5. The support according to claim 4, wherein the antirotation means have a notch formed on the axial sleeve and a complementary outward projection formed on an internal face of the conduit of the base.

6. The support according to claim 1, wherein the attachment interface has a plurality of spacers between the axial sleeve and the annular external portion, the openings being arranged respectively between two adjacent spacers in an annular space formed between the axial sleeve and the annular external portion.

7. The support according to claim 4, wherein the attachment interface has a plurality of spacers and the antirotation means comprise outward projections formed integrally with the base, each of the spacers extending through a space formed between two adjacent outward projections.

8. The support according to claim 1, wherein the first extremity of the axial sleeve projects axially toward the exterior from a transverse plane defined by an upper face of the annual external portion to form a male connection element.

9. The support according to claim 1, wherein the first extremity of the axial sleeve is welded to the conduit of the base, the welding zone forming said first sealing zone.

10. The support according to claim 1, wherein the annular external portion of the attachment interface has an external face on which is formed a peripheral groove that emerges radially toward the exterior, an annular seal being arranged in the groove and resting against a tubular wall of the base to form said second annular sealing zone.

11. The support according to claim 10, wherein the base has an internal collar that surrounds the axial sleeve, the annular external portion extending around the internal collar.

12. In a liquid filter, a combination of a mounting support according to claim 1 and a filter canister attached in removable manner on the support, the filter canister having an external housing delimiting an interior volume containing a filter element that separates said interior volume into an upstream space and a downstream space, the housing comprising a bottom delimiting at least one liquid inlet passageway that communicates with the upstream space and a liquid outlet passageway that communicates with the downstream space, said housing being suitable for mounting on the support, which has a liquid inlet channel provided to communicate with the inlet passageway and a liquid outlet channel provided to communicate with the outlet passageway.

13. The combination according to claim 12, wherein the filter canister is a crimped canister and wherein the annular external portion of the attachment interface has an external diameter that is appreciably equal to the external diameter of the housing of the canister.
